(19) United States
(12) Patent Application Publication
(10) Pub. No.: US 2004/0258469 A1
(43) Pub. Date: Dec. 23, 2004

(54) Magnetically controlled rod-assembly

(76) Inventor: Frank Hofmann, Attendorn-Helden (DE)

Correspondence Address: Andrew G. Kolomayets, Cook, Alex, McFarron, Manzo,, Cummings & Mehler, Ltd., 200 West Adams Street - Suite 2850, Chicago, IL, 60606, US

(21) Appl. No.: 10/779,470

(22) Filed: Feb. 13, 2004

Related U.S. Application Data
(63) Continuation of application No. PCT/EP02/08870, filed on Aug. 8, 2002.

(30) Foreign Application Priority Data
Aug. 16, 2001 (DE) 101 40 308.9

(51) Int. Cl. F16D 1/00

(52) U.S. Cl. 403/327

(57) ABSTRACT

The invention relates to a connecting system with locking elements for connecting bodies and individual parts, it being possible for the locking elements to be moved into or out of the locking position by magnetic force.

The invention relates to a connection for longitudinal bodies, in particular for rod linkages, as are used for horizontal ground drilling, and claims the priority of German patent application 101 40 308.9-24.

In horizontal ground drilling, for the static advancement, a drilling tool is moved through the earth by means of a push-rod or pull-rod linkage, which is connected to a pushing or pulling drive.

Such a rod linkage comprises individual lengths of rod which are usually connected to one another and released from one another via an end thread.

Since such threaded connections are only suitable for the transmission of a torque in one direction of rotation and in addition, under site conditions, tend toward contamination, wear, connection difficulties and a risk of breakage, rod-length connections which avoid a thread and, for example via a form-fitting connection, avoid the susceptibility of threaded connections to the risk of breakage in particular have been developed.

DE 198 14 232 A1 discloses a rod linkage in which the lengths of rod are connected to one another via a ladder-like plug-in system.

DE 199 23 555 A1 discloses a rod-linkage connection in which the lengths of rod are rotated into the drilling axis about an axis located perpendicularly to the drilling axis and/or about a pin located along this axis.

It is also the case in other areas of technology that longitudinal bodies are connected to one another via plug-in or screw connections in order to transmit a force, to ensure a stable hold or, as in the case of compressed-air-line couplings, to transfer compressed air.

In the cases mentioned, the operation of making or releasing the connection is force-intensive or time-consuming or, as in the case of the screw connection, does not provide the desired stability.

The object of the invention is thus to provide a connecting means which can be used to connect and release longitudinal bodies in a straightforward manner. The invention is particularly suitable as a connecting system for lengths of rod for horizontal ground drilling.

The object is achieved by a connecting means for longitudinal bodies according to claim 1. Advantageous configurations can be gathered from the subclaims.

Using the connecting means according to the invention, it is possible for lengths of rod in particular for horizontal drilling, but also for deep drilling, to be quickly and easily connected and released without any risk of breakage at the undercut thread or any particular susceptibility to contamination. Furthermore, such connections allow the longitudinal bodies or drilling rods to be forced in two directions by a torque without any risk of the connection being released.

However, rather than being limited to the abovementioned use examples, the invention is suitable for any connection between a shaft or a similar longitudinal body and a counterpart corresponding to a socket. Furthermore, the invention allows the connection to be made and released in a contact-free manner.

The invention can thus be used, for example, for controllable drilling installations, in order to allow the transmitter housing to be straightforwardly fitted and released on the drill bit. It is currently necessary for such transmitter housings to be unscrewed by aluminum pliers. Since such drilling installations use a torque of a few 1000 Nm, the forces which are necessary for releasing the transmitter housing are considerable and are accompanied, at the same time, by a risk of injury. Using the connection according to the invention, such transmitter housings can be drawn off from the drill bit simply by virtue of the magnetic force being exerted. This can take place with the aid of a permanent magnet or by means of an electromagnet.

The main idea of the invention is to use magnetic force to move locking elements of a longitudinal body in order to make and release the connection. The locking elements are preferably located in a spring-force-induced basic position. This basic position may constitute the unlocked or the locked position of the locking elements.

The locking elements may be designed in the form of one or more sliding bolts which are distributed over the circumference of the longitudinal body and, for locking purposes, are pushed into a groove provided in a longitudinal-body end. The locking elements may also be designed as ring segments of a subdivided ring. This allows a particularly secure fit of the connection and a high level of force transmission along the longitudinal-body axis.

For release of the connection, use is preferably made of an electromagnet, which is positioned on the circumference of the longitudinal body and is switched on in order to release the connection.

In the case of the preferred embodiment for rod-linkage connections, one side of the length of rod has, at its end, an undercut for the locking elements and also a wrench surface for transmitting torque in both directions. The corresponding other rod-length end has a corresponding wrench surface and a circumferential groove for accommodating the locking elements. The device is suitable for any kind of force transmission and can easily be released by placing the electromagnet in position, it being possible for the locking elements to be released from the circumferential groove of the male rod-length end and moved back into the undercut in order to free the connection.

The invention can be used with one or more locking elements and is suitable for any type of connecting system, and so also for a plug-in connection as is known for connecting a lamp or bulb to its base or a wall outlet.

The locking elements may also be designed as a displaceable bolt or pin which is fixed at one connecting end and, for connection to the other connecting end, moves into a bore provided for this purpose.

The device according to the invention is also suitable for replacing connections which are usually made nowadays by connecting rings seated in a groove and which are released by virtue of the partially interrupted ring being bent open. Instead of such rings being bent open with the aid of a special tool attached in a force-fitting or form-fitting manner at the end, such rings are opened according to the invention with the aid of the magnetic force.

The locking elements may be prestressed by elastomer elements and positioned, and secured in position, by guide elements.

Instead of the conventional spring steel, it is also possible to use an interrupted plastic ring, provided the latter has magnetizable parts or is produced with metal powder.

It is also conceivable to reverse the action according to the invention, in which case the locking elements are displaced not by the release device being magnetic and the locking elements being magnetizable, but by the locking elements being magnetic and the release device being in the form of a magnetizable counterpart. Such an arrangement is expedient in particular circumstances, where the surroundings of the locking elements should be essentially non-magnetizable.

The locking elements according to the invention may also be designed as mutually opposite half-rings in the form of coupling jaws and have a hinge, this resulting in a similar movement sequence as in the case of spring steel.

As an alternative, the locking elements may be retained in a certain basic position by a flexible connection, for example a rubber ring.

The invention will now be explained in more detail with reference to an exemplary embodiment illustrated in the drawing, in which:

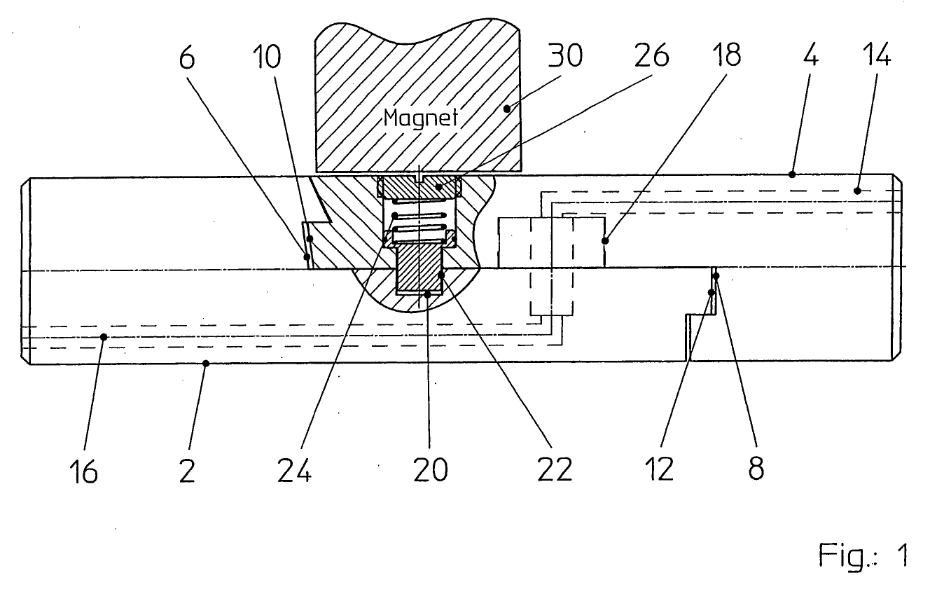

FIG. 1 shows lengths of rod locked by a locking element according to the invention;

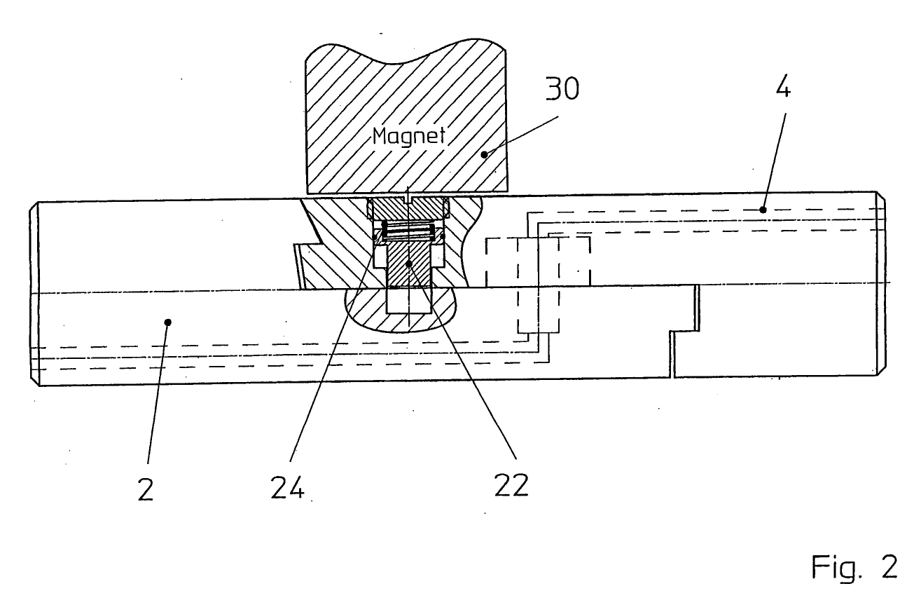

FIG. 2 shows the lengths of rod from FIG. 1 following release of the locking element;

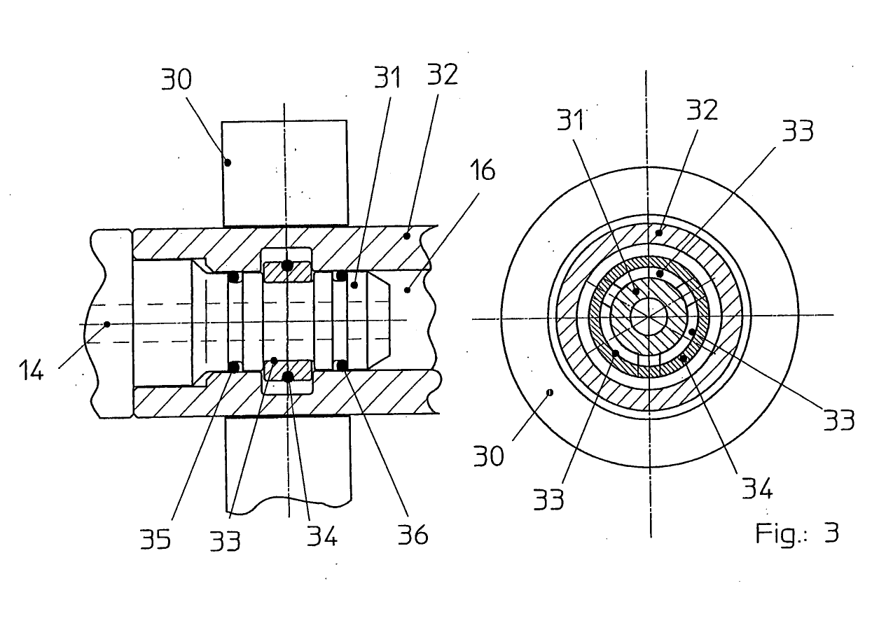

FIG. 3 shows the locking elements designed as ring segments;

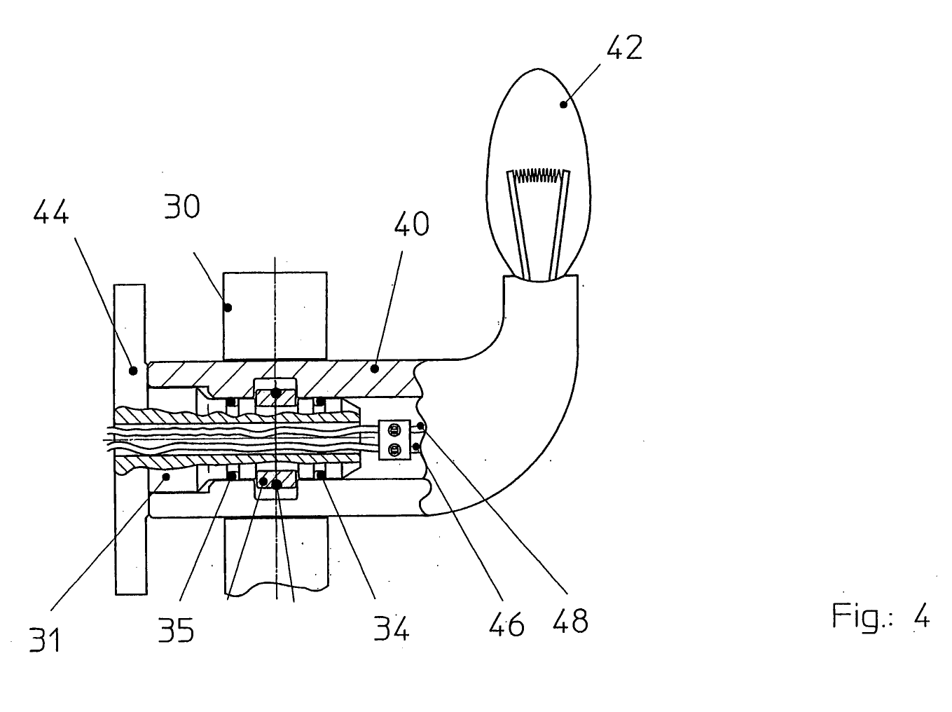

FIG. 4 shows the locking element of FIG. 3 for locking a lampholder; and

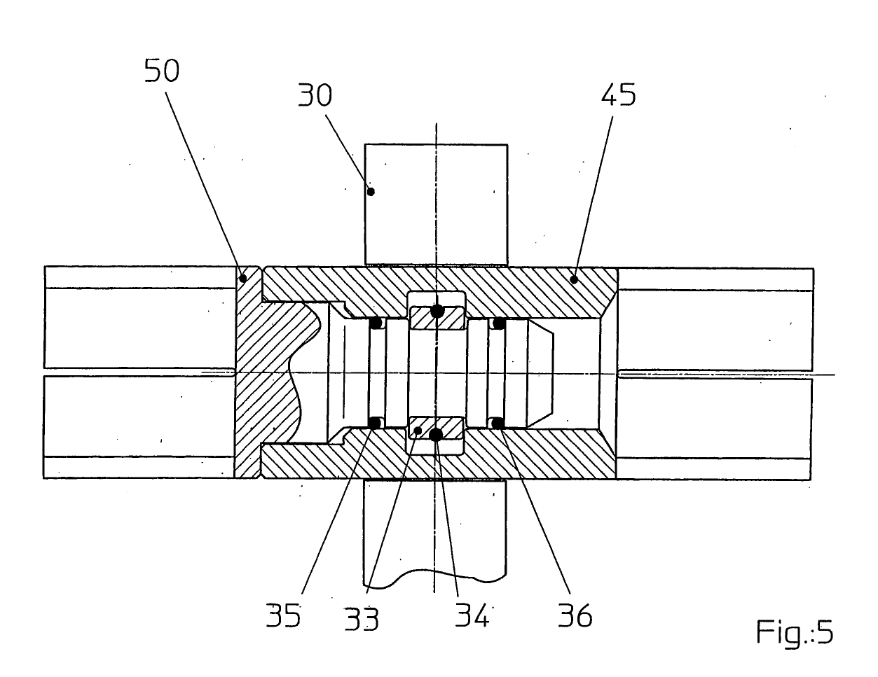

FIG. 5 shows the locking element of FIG. 3 for connecting two shafts.

FIG. 1 illustrates lengths of rod 2, 4 in plugged-together form with the magnet switched off. The rod-length ends have undercuts 6, 8 and corresponding noses 10, 12 for force-transmission purposes. In order to transfer drilling liquid, for example, the lengths of rod 2, 4 have channels 14, 16 connected to one another via a stub 18.

The length of rod 2 has a hole 20, in which a locking element 22 of the length of rod 4 engages. The locking element is retained in this position by the force of the spring 24 and is arranged in the ends of the length of rod 4 such that it can be displaced in a bore 26 provided for this purpose.

In order to release the connection, a magnet is positioned in the region of the locking element 22 at the end of the length of rod 4, as a result of which the locking element 22 is displaced into the position illustrated in FIG. 2 by the magnetic force, preferably of an electromagnet 30, overcoming the spring force of the spring 24.

In FIG. 2, the electromagnet has been switched on, with the result that the magnetic force has caused the locking element to be displaced and the connection to be freed.

As is illustrated in FIG. 3, the locking system according to the invention may also ring segments 34 for locking a plug-in connection for a compressed-air system, comprising a socket 32 and a connecting stub 31, arranged therein, with sealing rings 35, 36, ring segments 34, depending on the locking position, being located inside or outside an annular groove 33 with the aid of the electromagnet 30. The connecting system, however, is also suitable for connecting a base 40 of a lamp 42 to a wall outlet 44, electric lines 46, 48 passing through the stub 31 and providing the electrical connection to the lamp 42 (FIG. 4). It is thus possible for lamps to be quickly and easily connected to a wall outlet, and released therefrom, without effort having to be expended on screw connection.

It is likewise possible for the connection system according to the invention to be used for connecting shafts 45, 50 (FIG. 5).

1. A connecting system with locking elements for locking and unlocking bodies, characterized in that the locking elements (22) can be moved into or out of the locking position by magnetic force.

2. The connecting system as claimed in claim 1, characterized in that the locking elements (22) are magnetizable.

3. The connecting system as claimed in claim 1, characterized in that the locking elements (22) lock in their basic position.

4. The connecting system as claimed in claim 1, characterized in that the locking elements (22) are unlocked in their basic position.

5. The connecting system as claimed in claim 4, characterized in that the locking elements (22) are retained in their basic position by means of spring force.

6. The connecting system as claimed in claim 1, characterized in that the locking elements (22) are designed as ring segments.

7. The connecting system as claimed in claim 1, characterized in that the locking elements (22) are designed as an interrupted ring.

8. A magnetic unlocking means for a rod-linkage connection with magnetizable locking elements.

9. The magnetic unlocking means as claimed in claim 8, characterized by an electromagnetic locking unit.

10. The magnetic unlocking means as claimed in claim 8, characterized by a permanently magnetic locking unit.

11. A method of releasing and connecting elements, characterized by the magnetically induced movement of one or more locking components arranged in the region of the connecting ends.

12-15. (Canceled)
